(19) United States
(12) Patent Application Publication
(10) Pub. No.: US 2015/0077530 A1
(43) Pub. Date: Mar. 19, 2015

(54) DISPLAY APPARATUS AND METHOD AND CONTROL METHOD THEREOF

(71) Applicant: SAMSUNG ELECTRONICS CO., LTD., Suwon-si (KR)

(72) Inventor: Sung-chang JANG, Suwon (KR)

(21) Appl. No.: 14/298,609

(22) Filed: Jun. 6, 2014

(30) Foreign Application Priority Data
Sep. 17, 2013 (KR) 10-2013-0111938

(51) Int. Cl. H04N 13/04

(52) U.S. Cl. CPC H04N 13/0429
USPC 348/56

(57) ABSTRACT

Apparatuses and methods related to a display apparatus and a control method thereof, are provided. More particularly, the apparatuses and methods relate to a display apparatus which provides a 3D image or a multi-view image through shutter glasses and a control method thereof.

### CROSS-REFERENCE TO RELATED APPLICATIONS

This application claims priority from Korean Patent Application No. 10-2013-0111938, filed on Sep. 17, 2013 in the Korean Intellectual Property Office, the disclosure of which is incorporated herein by reference.

### BACKGROUND

1. Field

Apparatuses and methods consistent with the exemplary embodiments relate to a display apparatus and a control method thereof, and more particularly to a display apparatus which provides a 3D image or a multi-view image through shutter glasses and a control method thereof.

2. Description of the Related Art

A display apparatus such as a television (TV) processes an image signal received from an external image source and displays it as an image on a liquid crystal display panel or the like.

In accordance with required viewing environments, the display apparatus may display a two-dimensional (2D) or a three-dimensional image, or provide a multi-view image to a user.

Here, the 3D image is based on binocular parallax that is the biggest factor contributing to a three-dimensional effect on an object in a short range. The 3D image is through shutter-type glasses (hereinafter, referred to as ‘shutter glasses’). The 3D image is achieved in such a manner that the display apparatus alternately displays a left-eye image and a right-eye image and the shutter glasses are opened and closed in sync with a left-eye image and a right-eye image.

Also, the multi-view image is also through the shutter glasses. Similarly to the principle of divisionally displaying a left-eye image and a right-eye image, the multi-view image is achieved in such a manner that the display apparatus divisionally displays two or more contents images and a plurality of users selects and synchronizes these content-images.

In terms of using the shutter glasses, a current user environment for viewing a 3D image or a multi-view image is as follows: a user has to set up the display apparatus to turn on a 3D mode or a multi-view mode with regard to an input image and then operate the shutter glasses, thereby viewing a 3D image or a multi-view image. Accordingly, it is inconvenient for a user to not only operate the shutter glasses but also control the display apparatus to be set up into the 3D mode or the multi-view mode before viewing a 3D image or a multi-view image.

### SUMMARY

Additional aspects and/or advantages will be set forth in part in the description which follows and, in part, will be apparent from the description, or may be learned by practice of the invention.

One or more aspects of the exemplary embodiment provides a display apparatus and a control method thereof, in which a user who uses a pair of shutter glasses to view a 3D image or a multi-view image in the display apparatus can easily view a 3D image or a multi-view image through only a simple operation for the shutter glasses without separately controlling a 3D mode or a multi-view mode in the display apparatus.

According to an aspect of another exemplary embodiment, there is provided a display apparatus including: an image processor which processes an image processor; a display which displays the processed image; a communicator which communicates with at least one pair of shutter glasses; a controller which checks a state of the shutter glasses, and controls the display to display an image corresponding to one between a normal mode without the shutter glasses and a glasses mode with the shutter glasses in accordance with the state.

In the glasses mode, a 3D image or a multi-view image may be displayed.

The state of the shutter glasses may include a state of being paired with the communicator.

The state of the shutter glasses may include a state about connection with the communicator, and the controller may be configured to control the display to display an image corresponding to the glasses mode when the communicator connects with the shutter glasses.

The controller may be configured to control the display to display an image corresponding to the normal mode when the communicator is disconnected from the shutter glasses.

The state of the shutter glasses may include a state about a shuttering operation, and the controller may be configured to control the display to display an image corresponding to the glasses mode when the shutter glasses perform the shuttering operation.

The controller may be configured to control the display to display an image corresponding to the normal mode when the shutter glasses terminate the shuttering operation.

The state of the shutter glasses may include a state about being turned on/off, and the controller may be configured to control the display to display an image corresponding to the glasses mode when the shutter glasses are turned on.

The controller may be configured to control the display to display an image corresponding to the normal mode when the shutter glasses are turned off.

The controller may be configured to send the shutter glasses information about readiness for displaying an image corresponding to the glasses mode when the shutter glasses operate for the glasses mode.

According to an aspect of another exemplary embodiment, there is provided a method of controlling a display apparatus including: checking a state of at least one pair of shutter glasses; and displaying an image corresponding to one between a normal mode without the shutter glasses and a glasses mode with the shutter glasses in accordance with the state.

The displaying may include displaying a 3D image or a multi-view image in the glasses mode.

The checking the state of the shutter glasses may include checking whether the display apparatus is paired with the shutter glasses.

The checking the state of the shutter glasses may include checking a connection state between the display apparatus and the shutter glasses, and the displaying may include displaying an image corresponding to the glasses mode when the display apparatus connects with the shutter glasses.

The displaying may include displaying an image corresponding to the normal mode when the display apparatus is disconnected from the shutter glasses.

The checking the state of the shutter glasses may include checking a state about an shuttering operation, and

The displaying may include displaying an image corresponding to the glasses mode when the shutter glasses perform the shuttering operation.

The displaying may include displaying an image corresponding to the normal mode when the shutter glasses terminate the shuttering operation.

The checking the state of the shutter glasses may include checking a state about being turned on/off, and

The displaying may include displaying an image corresponding to the glasses mode when the shutter glasses are turned on.

The displaying may include displaying an image corresponding to the normal mode when the shutter glasses are turned off.

The method may be provided further including sending the shutter glasses information about readiness for displaying an image corresponding to the glasses mode when the shutter glasses operate for the glasses mode.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a block diagram of a display apparatus according to an exemplary embodiment;

FIGS. 2 to 5 show a process of displaying an image in accordance with shutter glasses of the display apparatus according to an exemplary embodiment;

FIG. 6 shows operations of the display apparatus according to an exemplary embodiment; and

FIGS. 7 and 8 are flowcharts showing control methods of the display apparatus according to an exemplary embodiment.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

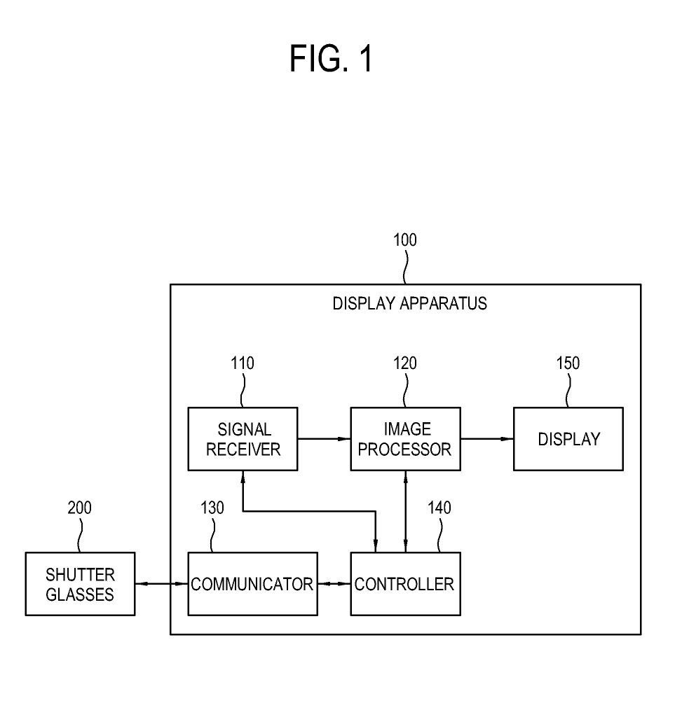

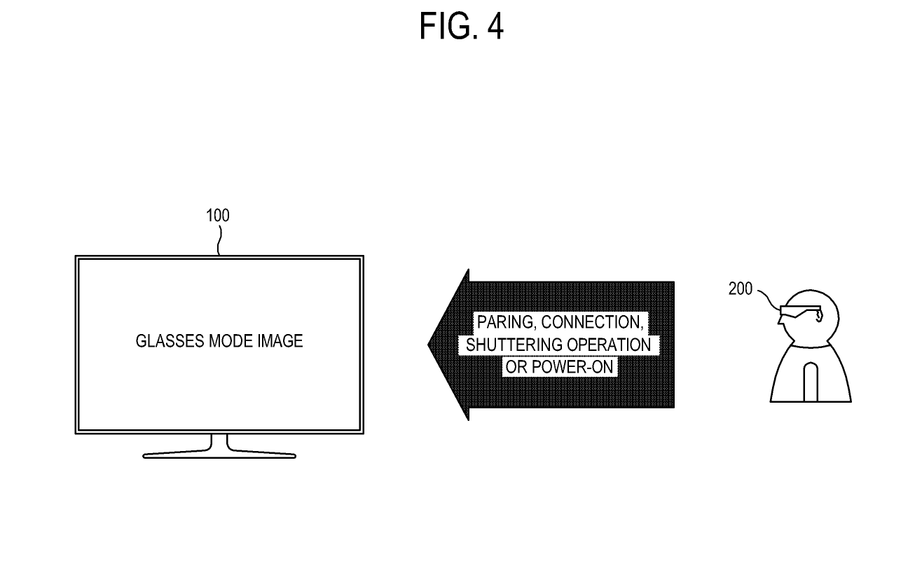

First, elements included in the display apparatus according to an exemplary embodiment will be explained in detail with reference to FIG. 1, and with reference to FIGS. 4 to 8 as necessary. FIG. 1 is a block diagram of a display apparatus according to an exemplary embodiment. As shown in FIG. 1, a display apparatus 100 may include a signal receiver 110, an image processor 120, a communicator 130, a controller 140, and a display 150. Further, the display apparatus 100 may connect with shutter glasses 200. For example, the display apparatus 100 may be achieved by a TV. The shutter glasses 200 is a pair of shutter-type glasses, in which a left-eye shutter and a right-eye shutter are opened and closed in sync with a left-eye image and a right-eye image of the display apparatus 100, thereby achieving a 3D image. For instance, when the display apparatus 100 displays a left-eye image, the pair of shutter glasses opens the left-eye shutter but closes the right-eye shutter. On the other hand, when the display apparatus 100 displays a right-eye image, the pair of shutter glasses opens the right-eye shutter but closes the left-eye shutter.

The signal receiver 110 may receive an image signal corresponding to at least one channel. The signal receiver 110 may be achieved in various forms according to formats of a received image signal and types of the display apparatus 100. For example, the signal receiver 110 may be achieved by a tuner for receiving a radio frequency (RF) broadcasting signal from a broadcasting station. Also, the signal receiver 110 may be achieved in the form of connecting with and receiving an image signal from a peripheral imaging device such as a digital versatile disc (DVD) or a personal computer (PC).

The image processor 120 processes an image signal in accordance with a preset imaging process. As an example of the imaging process performed in the image processor 120, there are decoding, de-interlacing, scaling, noise reduction, detail enhancement, etc., but not limited thereto. The image processor 120 may be achieved by a system-on-chip where such many functions are integrated, or by an imaging process board to which individual elements for independently performing each process are mounted.

The display 150 displays an image based on an image signal output from the image processor 120. The display 150 may be achieved by a plasma display panel (PDP), a liquid crystal display (LCD), an organic light emitting diode (OLED), a flexible display, etc. without limit.

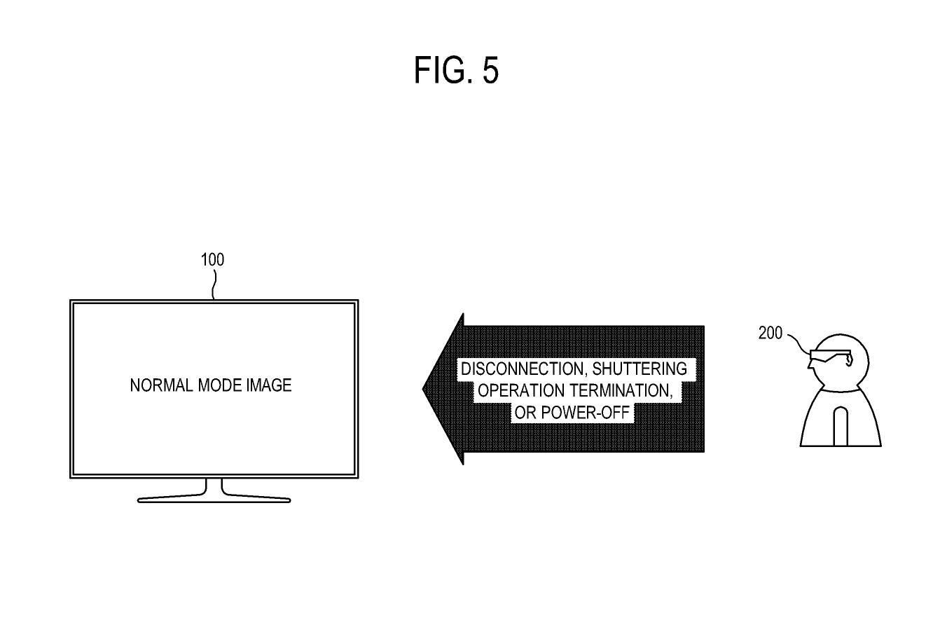

The communicator 130 performs communication with at least one pair of shutter glasses 200. For example, as shown in FIGS. 4 and 5, the communication may include pairing with the shutter glasses 200 through an RF signal, or transmitting/receiving data through connection with the shutter glasses 200 after the pairing. Also, the communicator 130 may transmit and receive a signal about shutting operations and power on/off of the shutter glasses 200.

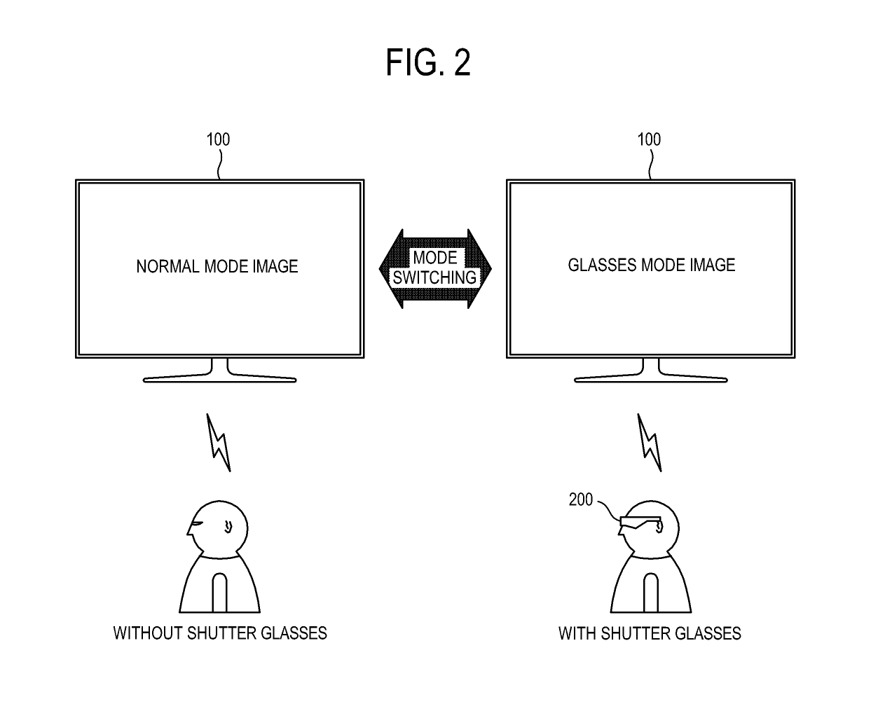

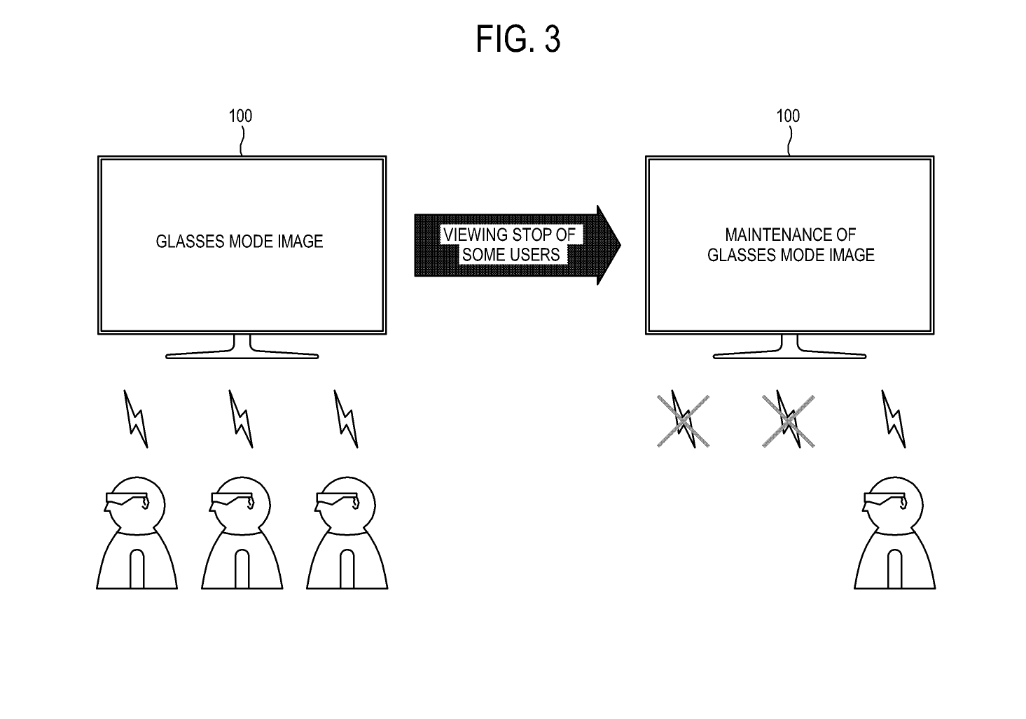

As shown in FIG. 2, the controller 140 checks a state of the shutter glasses 200 and controls the display 150 to display an image corresponding to one mode between a normal mode without the shutter glasses 200 and a glasses mode with the shutter glasses 200 in accordance with the checked states. At this time, the image corresponding to the glasses mode may include a 3D image or a multi-view image. In the case of the multi-view image, at least one user can view different images through a full screen. According to an exemplary embodiment, as shown in FIG. 3, even though some users stop viewing midway while a plurality of users views the multi-view images corresponding to the glasses mode, the display apparatus 100 can maintain the image corresponding to the glasses mode.

In the exemplary embodiments shown in FIGS. 4 and 5, images corresponding to the normal mode and the glasses mode are displayed on the display 150 in accordance with the states of the shutter glasses 200. Here, the state of the shutter glasses 200 may include a state of being paired with the communicator 130, and the controller 140 may control the display 150 to display an image corresponding to the glasses mode when the communicator 130 is paired with and the shutter glasses 200.

Also, the state of the shutter glasses 200 may include a state about connection with the communicator 130. At this time, the controller 140 controls the display 150 to display an image corresponding to the glasses mode when the communicator 130 connects with the shutter glasses 200, On the other hand, the controller 140 controls the display 150 to display an image corresponding to the normal mode when the communicator 130 is disconnected from the shutter glasses 200.

Also, the state of the shutter glasses 200 may include a state about a shuttering operation. At this time, the controller 140 controls the display 150 to display an image corresponding to the glasses mode when the shutter glasses 200 perform the shuttering operation. On the other hand, the controller 140 controls the display 150 to display an image corresponding to the normal mode when the shutter glasses 200 terminate the shuttering operation.

Also, the state of the shutter glasses 200 may include a state about power on/off. At this time, the controller 140 controls the display 150 to display an image corresponding to the glasses mode when the shutter glasses 200 are turned on. On the other hand, the controller 140 controls the display 150 to display an image corresponding to the normal mode when the shutter glasses 200 are turned off.

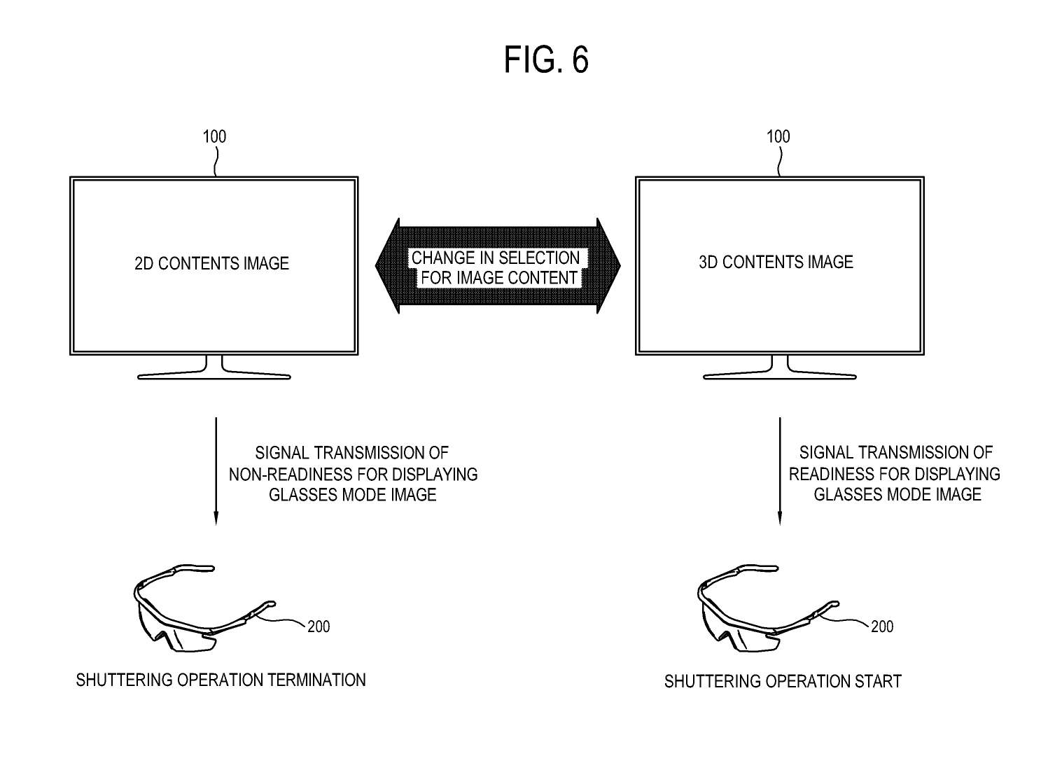

Meanwhile, the controller 140 may send the shutter glasses 200 information about readiness for displaying an image corresponding to the glasses mode when the shutter glasses 200 operate for the glasses mode. For example, as shown in FIG. 6, in viewing a 3D image through the shutter glasses 200, if a user does not select a 3D contents image for the glasses mode, the controller 140 sends the shutter glasses 200 a signal of non-readiness for displaying an image corresponding to the glasses mode so that the shutter glasses 200 can stop the shuttering operation. On the other hand, if a user selects a 3D contents image for the glasses mode, the controller 140 sends the shutter glasses 200 a signal of readiness for displaying an image corresponding to the glasses mode so that the shutter glasses 200 can start the shuttering operation. In this case, even though a user does not select a 3D contents image, a 2D contents image can be clearly viewed through the shutter glasses 200.

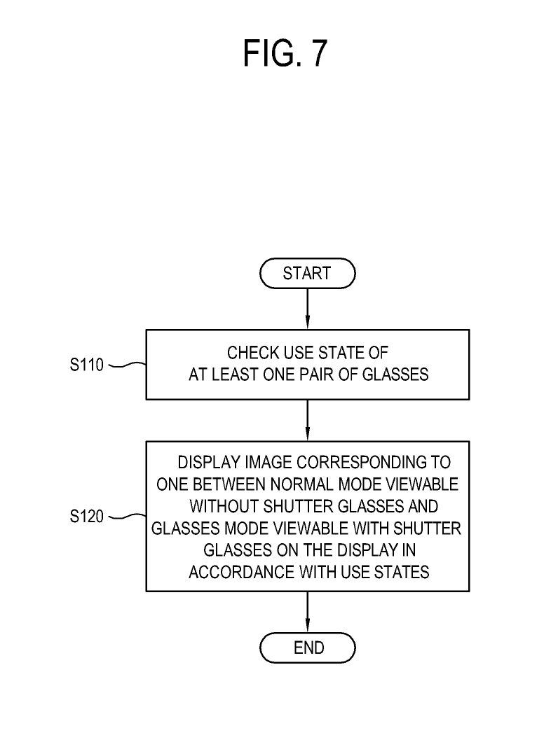

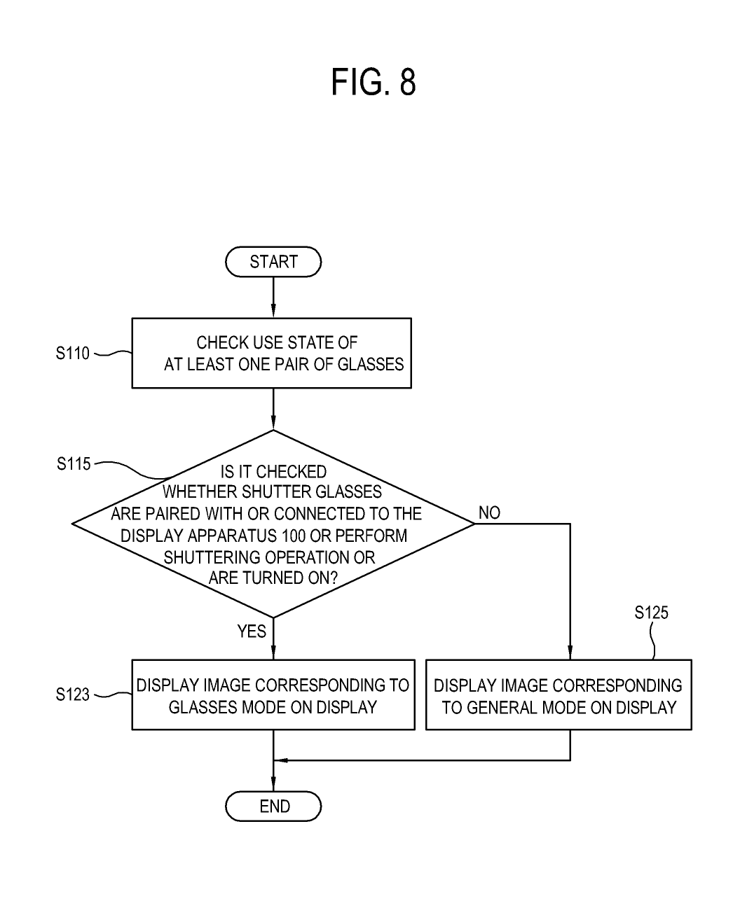

Below, a control method of the display apparatus will be described with reference to FIGS. 7 and 8. FIG. 7 is a flowchart showing the control method of the display apparatus according to an exemplary embodiment. As shown in FIG. 7, at operation S110, the display apparatus 100 checks the states of at least one pair of shutter glasses 200.

Here, the operation S110 of checking the state of the shutter glasses 200 may include checking a pairing state between the display apparatus 100 and the shutter glasses 200, or checking a connection state between the display apparatus 100 and the shutter glasses 200. Also, the operation S110 of checking the state of the shutter glasses 200 may include checking the shuttering operation of the shutter glasses 200, or checking the power on/off state of the shutter glasses 200.

Next, at operation S120, an image corresponding to one between the normal mode without the shutter glasses 200 and the glasses mode with the shutter glasses 200 is displayed on the display 150 in accordance with the states. Here, the operation S120 of displaying the image on the display 150 may include displaying a 3D image or a multi-view image in the glasses mode.

FIG. 8 shows operations similar to FIG. 7, but explains the control method of the display apparatus in more detail.

First, at operation S110, the display apparatus 100 checks the state of at least one pair of shutter glasses 200.

As an exemplary embodiment, at operation S115, it is checked whether the display apparatus 100 is paired with the shutter glasses 200. If the display apparatus 100 is paired with the shutter glasses 200, at operation S123 an image corresponding to the glasses mode is displayed.

Alternatively, at operation S115, it is checked whether the display apparatus 100 connects with the shutter glasses 200. If the display apparatus 100 connects with the shutter glasses 200, at operation S123 an image corresponding to the glasses mode is displayed. On the other hand, if the display apparatus 100 is disconnected from the shutter glasses 200, at operation S125 an image corresponding to the normal mode is displayed.

Alternatively, at operation S115, it is checked whether the shutter glasses 200 perform the shuttering operation. If the shutter glasses 200 perform the shuttering operation, at operation S123 an image corresponding to the glasses mode is displayed. On the other hand, if the shutter glasses 200 terminate the shuttering operation, at operation S125 an image corresponding to the normal mode is displayed.

Alternatively, at operation S115, it is checked whether the shutter glasses 200 are turned on. If the shutter glasses 200 are turned on, at operation S123 an image corresponding to the glasses mode is displayed. On the other hand, if the shutter glasses 200 are turned off, at operation S125 an image corresponding to the normal mode is displayed.

Here, the operation S123 of displaying an image corresponding to the glasses mode may include an operation of displaying a 3D image or a multi-view image.

According to an exemplary embodiment as described above, a user who uses a pair of shutter glasses to view a 3D image or a multi-view image in the display apparatus can easily view a 3D image or a multi-view image through only a simple operation for the shutter glasses without separately controlling a 3D mode or a multi-view mode in the display apparatus.

Although a few exemplary embodiments have been shown and described, it will be appreciated by those skilled in the art that changes may be made in these exemplary embodiments without departing from the principles and spirit of the invention. Therefore, the foregoing has to be considered as illustrative only. The scope of the invention is defined in the appended claims and their equivalents. Accordingly, all suitable modification and equivalents may fall within the scope of the invention.

What is claimed is:

1. A display apparatus comprising:
an image processor which processes an image;
a display which displays the processed image;
a communicator which communicates with at least one pair of shutter glasses;
a controller which checks a state of the shutter glasses, and controls the display to display an image corresponding to one between a normal mode without the shutter glasses and a glasses mode with the shutter glasses in accordance with the state.

2. The display apparatus according to claim 1, wherein in the glasses mode, a 3D image or a multi-view image is displayed.

3. The display apparatus according to claim 1, wherein the state of the shutter glasses comprises a state of being paired with the communicator.

4. The display apparatus according to claim 1, wherein
the state of the shutter glasses comprises a state about connection with the communicator, and
the controller controls the display to display an image corresponding to the glasses mode when the communicator connects with the shutter glasses.

5. The display apparatus according to claim 4, wherein the controller controls the display to display an image corresponding to the normal mode when the communicator is disconnected from the shutter glasses.

6. The display apparatus according to claim 1, wherein
the state of the shutter glasses comprises a state about a shuttering operation, and
the controller controls the display to display an image corresponding to the glasses mode when the shutter glasses perform the shuttering operation.

7. The display apparatus according to claim 6, wherein the controller controls the display to display an image corresponding to the normal mode when the shutter glasses terminate the shuttering operation.

8. The display apparatus according to claim 1, wherein
the state of the shutter glasses comprises a state about being turned on/off, and
the controller controls the display to display an image corresponding to the glasses mode when the shutter glasses are turned on.

9. The display apparatus according to claim 8, wherein the controller controls the display to display an image corresponding to the normal mode when the shutter glasses are turned off.

10. The display apparatus according to claim 1, wherein the controller sends the shutter glasses information about readiness for displaying an image corresponding to the glasses mode when the shutter glasses operate for the glasses mode.

11. The display apparatus according to claim 1, further comprising: at least one pair of the shutter glasses to watch the image on the display.

12. The display apparatus according to claim 1, further comprising: a signal receiver to receive the signal.

13. A method of controlling a display apparatus, the method comprising:
checking a state of at least one pair of shutter glasses; and
displaying an image corresponding to one between a normal mode without the shutter glasses and a glasses mode with the shutter glasses in accordance with the state.

14. The method according to claim 13, wherein the displaying comprises displaying a 3D image or a multi-view image in the glasses mode.

15. The method according to claim 13, wherein the checking the state of the shutter glasses comprises checking whether the display apparatus is paired with the shutter glasses.

16. The method according to claim 13, wherein
the checking the state of the shutter glasses comprises checking a connection state between the display apparatus and the shutter glasses, and
the displaying comprises displaying an image corresponding to the glasses mode when the display apparatus connects with the shutter glasses.

17. The method according to claim 16, wherein the displaying comprises displaying an image corresponding to the normal mode when the display apparatus is disconnected from the shutter glasses.

18. The method according to claim 13, wherein
the checking the state of the shutter glasses comprises checking a state about an shuttering operation, and
the displaying comprises displaying an image corresponding to the glasses mode when the shutter glasses perform the shuttering operation.

19. The method according to claim 18, wherein the displaying comprises displaying an image corresponding to the normal mode when the shutter glasses terminate the shuttering operation.

20. The method according to claim 13, wherein
the checking the state of the shutter glasses comprises checking a state about being turned on/off, and
the displaying comprises displaying an image corresponding to the glasses mode when the shutter glasses are turned on.

21. The method according to claim 20, wherein the displaying comprises displaying an image corresponding to the normal mode when the shutter glasses are turned off.

22. The method according to claim 13, further comprising sending the shutter glasses information about readiness for displaying an image corresponding to the glasses mode when the shutter glasses operate for the glasses mode.
